(19) United States
(12) Patent Application Publication
(10) Pub. No.: US 2025/0030193 A1
(43) Pub. Date: Jan. 23, 2025

(54) Electrical Connector and Method of Manufacturing an Electrial Connector

(71) Applicant: Tyco Electronics France SAS, Pontoise (FR)

(72) Inventors: Xavier ROUILLARD, Pontoise (FR); Joseph DAHER, Pontoise (FR); Carlos SALGADO, Pontoise (FR)

(73) Assignee: Tyco Electronics France SAS, Pontoise (FR)

(21) Appl. No.: 18/777,650

(22) Filed: Jul. 19, 2024

(30) Foreign Application Priority Data
Jul. 21, 2023 (FR) 2307900

(51) Int. Cl. H01R 13/533; H01R 24/20; H01R 43/20; H01R 43/26

(52) U.S. Cl. CPC H01R 13/533; H01R 24/20; H01R 43/20; H01R 43/26

(57) ABSTRACT

An electrical connector configured to be mated with an electrical counter-connector, the electrical connector comprising a housing member, an electrical terminal housed in a corresponding terminal cavity of the housing member, and an anti-vibration element. The electrical connector is characterized in that the housing member further comprises a traversing groove traversing the housing member from an external housing member surface to an internal housing member surface that defines the corresponding terminal cavity, and the anti-vibration element is arranged in the traversing groove. The invention further relates to an electrical connector assembly comprising the electrical connector and an electrical counter-connector, to a method of assembling the electrical connector assembly, and to a method of manufacturing an electrical connector, in particular the electrical connector of the invention.

This application claims priority to and the benefit of French Patent Application No. 2307900 filed Jul. 21, 2023, which is hereby incorporated by reference in its entirety.

The present invention relates to an electrical connector comprising an electrical terminal and an anti-vibration element. The invention also relates to an electrical connector assembly thereof, to a method of assembling the electrical connector assembly, and to a method of manufacturing an electrical connector.

Electrical connectors are known in the art that comprise a housing member and one or more electrical terminals. The electrical terminals are housed in corresponding terminal cavities of the housing member. The electrical terminals are configured to electrically contact respective mating electrical terminals of a mating electrical counter-connector when the electrical connector is mated with said counter-connector.

An electrical terminal can be fit in its corresponding terminal cavity of the housing member, for example, by form-fit or friction-fit. It is preferable to avoid friction-fitting of the electrical terminal to reduce the risk of material degradation on both the housing member and the electrical terminal from frictional strain, which may impact durability and quality of the electrical contact. Therefore, a variety of form-fitting solutions for the fitting of an electrical terminal in a connector housing member have been devised, in particular cantilever-type snap-fit devices.

However, the given manufacturing tolerances for the electrical terminal and the housing member will often yield a snap-fitting of the electrical terminal in the housing member that still permits relative micro-movements. In the case of vibration-intensive environments, for example in proximity to a combustion engine, the relative micro-movements can materially degrade the electrical terminals and/or the housing member. In addition, the relative micro-movements can further increase fretting corrosion of the electrical terminal and the mating electrical terminal when the electrical connector is mated with the electrical counter-connector.

It is therefore an object of the present invention to provide an electrical contacting solution with improved vibration-resistance and improved durability in vibration-intensive environments.

This object is achieved with an electrical connector configured to be mated with an electrical counter-connector along a mating direction, the electrical connector comprising a housing member, one electrical terminal housed in a corresponding terminal cavity of the housing member, and an anti-vibration element. According to the present invention, the electrical connector is characterised in that the housing further comprises a traversing groove traversing from an external housing member surface to an internal housing member surface that defines the corresponding terminal cavity, and in that the anti-vibration element is arranged in the traversing groove.

As the traversing groove traverses the housing from an external housing member surface to an internal housing member surface that defines the corresponding terminal cavity, a space linking an outside of the housing member with the terminal cavity is created. By arranging the anti-vibration element in the traversing groove, the anti-vibration element can represent a direct mechanical link between the outside of the housing member and the terminal cavity holding the electrical terminal.

Thus, the anti-vibration element can be sandwiched, in particular between the electrical terminal and an actuation device outside the housing member, when said actuation device is positioned along the external housing member surface. This provides additional stabilisation of the electrical terminal in the terminal cavity, specifically in cases where manufacturing tolerance would still permit relative movements between an electrical terminal and a housing member.

In particular, when the electrical connector is mated along the mating direction with the electrical counter-connector, the electrical counter-connector can be the actuation device sandwiching, in particular compressing, the anti-vibration element with the electrical terminal. Thus, when the electrical counter-connector vibrates differently from the electrical connector, the vibrations of the electrical counter-connector can directly and additionally be transferred to the electrical terminal, further reducing the risk of fretting corrosion.

In one aspect, the anti-vibration element can be arranged in the traversing groove such that the anti-vibration element protrudes beyond the external housing member surface. Mechanical access to the anti-vibration element located in the traversing groove is thus facilitated.

In one aspect, the electrical connector can comprise a plurality of the electrical terminals housed in a respective plurality of corresponding terminal cavities of the housing member. The traversing groove extends along an outer periphery of the housing member such that it traverses the housing member from the external housing member surface to each of the respective internal housing member surfaces that define the plurality of corresponding terminal cavities. The anti-vibration element is arranged in the traversing groove such that it protrudes beyond the external housing member surface along the outer periphery.

In this configuration, a single anti-vibration element can be interfaced with a plurality of terminal cavities holding respective electrical terminals, at the same time. This means that the anti-vibration element can help to simultaneously stabilize the plurality of electrical terminals.

In one aspect, the traversing groove can extend along the entire circumference of the housing member, and the anti-vibration element is arranged in the traversing groove such that it protrudes beyond the external housing member surface along the entire circumference of the housing member.

In one aspect, the anti-vibration element can be formed in a shape matching the outer periphery of the housing member. The anti-vibration element can thus be conveniently arranged in the traversing groove so as to be interfaced with each of the plurality of corresponding terminal cavities.

In one aspect, the housing member can have a rectangular circumference in a plane orthogonal to the mating direction, and the anti-vibration element has a matching rectangular ring shape. With a ring-shaped anti-vibration element arranged in a circumferential traversing groove, an elastic property of the anti-vibration element can be provided that applies a stabilizing force inwardly and uniformly onto a plurality of electrical terminals housed in the housing member.

In one aspect, the anti-vibration element can be an O-ring. In this configuration, the electrical connector and, in particular, the anti-vibration element are thus particularly cost-effective to realize.

In one aspect, the anti-vibration element can be made of a rubber or a thermoplastic elastomer, in particular with a Shore hardness comprised between 50 and 30, preferably between 35 and 45. Anti-vibration elements thus configured are suited to provide a desired flexibility and elastic properties, without risking damage to the housing member or the electrical terminal,

In one aspect, the anti-vibration element can be arranged in the traversing groove such that it is in contact with the one or plurality of electrical terminals. Thus, any pressure or force applied to the anti-vibration element is directly and immediately also transferred to the electrical terminal, and the anti-vibration element and electrical terminal can move in conjunction.

In one aspect, the anti-vibration element can be arranged in the traversing groove such that it is frictionally engaged with the one or plurality of electrical terminals. This allows for improved stabilisation of the electrical terminals in their respective terminal cavities even when the electrical connector is in an uncoupled state.

In one aspect, the anti-vibration element can protrude beyond the internal housing member surfaces that define the one or plurality of corresponding terminal cavities, into said one or plurality of corresponding terminal cavities. In this configuration, a frictional engagement between the anti-vibration element and the electrical terminal can be obtained when the electrical terminal is fit, for example snap-fit, in its corresponding terminal cavity.

In one aspect, the traversing groove can traverse the housing member in a direction orthogonal to the mating direction. Therefore, when electrical terminals are housed in the housing member extending in parallel to the mating direction, the arrangement of the anti-vibration element to be interfaced with the one or plurality of electrical terminals is more convenient. That is, the distance from the external housing member surface and the internal housing member surface defining a corresponding terminal cavity can be shorter.

In one aspect, each of the one or plurality of electrical terminals can be a socket contact terminal comprising an internally narrowed portion configured to realize an electrical contact with a mating pin contact terminal. For each electrical terminal, the traversing groove traverses the housing from the external housing member surface to a portion of the internal housing member surface defining the corresponding terminal cavity that is face-to-face with the respective internally narrowed portion of the electrical terminal.

Thus, when a mechanical force compresses the anti-vibration element against the electrical terminal, the compression force is locally applied to the internally narrowed portion of the electrical terminal. That is, the location of the greatest compression force applied to the electrical terminal can be the internally narrowed portion of the electrical terminal, which, when the electrical connector is mated with the electrical counter-connector, includes the point or points of electrical contacting. Therefore, fretting corrosion resulting from micro-movements between the electrical terminal and a mating electrical terminal, configured as contact pin housed in the electrical counter-connector, can be reduced. Notably, when the anti-vibration element vibrates in conjunction with the electrical counter-connector, the vibrations of the electrical counter-connector and the mating electrical terminal are transferred to the point of electrical contacting.

The object of the invention is also achieved by means of an electrical connector assembly, comprising an electrical connector according to any one of the above-described aspects of the invention, and an electrical counter-connector comprising a shell member, wherein the electrical counter-connector is mated with the electrical connector such that the shell member envelops the housing member. A shell enveloping the housing can conveniently interact with a traversing groove extending along an outer periphery of the housing member of the electrical connector.

In one aspect of the electrical connector assembly, the electrical counter-connector can be mated with the electrical connector such that the anti-vibration element is compressed between the shell member and the one or plurality of electrical terminals. Thus, the anti-vibration element stabilizes the electrical terminal further in its cavity and in particular allows for the one or electrical terminals to vibrate with the electrical counter-connector, rather than the housing member of the electrical connector.

In one aspect of the electrical connector assembly, the shell member can comprise an inner surface with a chamfered portion configured to engage with the anti-vibration element, in particular for a compressing of the anti-vibration element between the shell member and the one or plurality of electrical terminals when the electrical counter-connector is mated with the electrical connector. The chamfered portion allows for a gradual compression of the anti-vibration element when the connectors of the electrical connector assembly are mated. This can improve the smoothness of the mating movement.

The invention also comprises a method for assembling the electrical connector assembly according to one of the preceding aspects. The method comprises the steps of mating the housing member and the shell member such that the shell member envelops the housing member, and compressing the anti-vibration element between the shell member and the electrical terminal.

When the electrical connector assembly is assembled according to this method, an electrical contacting between electrical terminals is achieved that provides the above-described advantages of the invention.

In one aspect of the method for assembling the electrical connector assembly, an inner surface of the shell member of the electrical counter-connector comprises a chamfered portion, and the step of compressing comprises a compressing between the chamfered portion and the electrical terminal. The chamfered portion allows for a gradual compression of the anti-vibration element when the connectors of the electrical connector assembly are mated. This can improve the smoothness of the mating movement.

The present invention further relates to a method for manufacturing an electrical connector, in particular the electrical connector according to one of the above-described aspects. The method for manufacturing an electrical connector comprises the steps of:
providing a housing member comprising a traversing groove traversing the housing member from an external housing member surface to an internal housing member surface that defines a terminal cavity for an electrical terminal;
arranging an anti-vibration element in the traversing groove such that the anti-vibration element protrudes beyond the external housing member surface, and
inserting an electrical terminal in the terminal cavity. The electrical connector manufactured according to this method solves the problem of the invention and, in particular, can achieve the above-described corresponding advantages of various aspects of the invention

In one aspect of the method for manufacturing the electrical connector, the electrical terminal is inserted in the terminal cavity such that the electrical terminal is in contact with, in particular frictionally engaged with, the anti-vibration element. Thus, any pressure or force applied to the anti-vibration element can be directly and immediately also transferred to the electrical terminal, and the anti-vibration element and electrical terminal can move in conjunction. A frictional engagement allows for improved stabilisation of the electrical terminals in their respective terminal cavities even when the electrical connector is in an uncoupled state.

In one aspect of the method for manufacturing the electrical connector, the electrical terminal is inserted in the terminal cavity such that an internally narrowed portion of the electrical terminal configured to realize an electrical contact with a mating electrical terminal is positioned face-to-face with the anti-vibration element and/or with a portion of the internal housing member surface defining the terminal cavity through which the traversing groove traverses the housing member.

Thus, when a mechanical force compresses the anti-vibration element against the electrical terminal, the compression force is locally applied to the internally narrowed portion of the electrical terminal(s), which, when the electrical connector is mated with the electrical counter-connector, includes the point or points of electrical contacting. Therefore, fretting corrosion resulting from micro-movements between the electrical terminal and a mating electrical terminal, configured as contact pin housed in the electrical counter-connector, can be reduced.

In one aspect of the method for manufacturing the electrical connector, the traversing groove of the housing member traverses the housing member from an external housing member surface to a plurality of internal housing member surfaces that define the plurality of corresponding terminal cavities for a respective plurality of electrical terminals, and the method further comprises additional steps of inserting the plurality of electrical terminals in their respective corresponding terminal cavities such that each of the plurality of electrical terminals is in contact with the anti-vibration element.

This method is particularly cost-efficient, both with respect to material costs and manufacturing steps cost, as a single anti-vibration element can be interfaced with a plurality of terminal cavities holding respective electrical terminals, at the same time.

The above-described aspects, objects, features and advantages of the present invention will be more completely understood and appreciated by careful study of the following more detailed description of a presently preferred exemplary embodiment of the invention, taken in conjunction with accompanying drawings, in which:

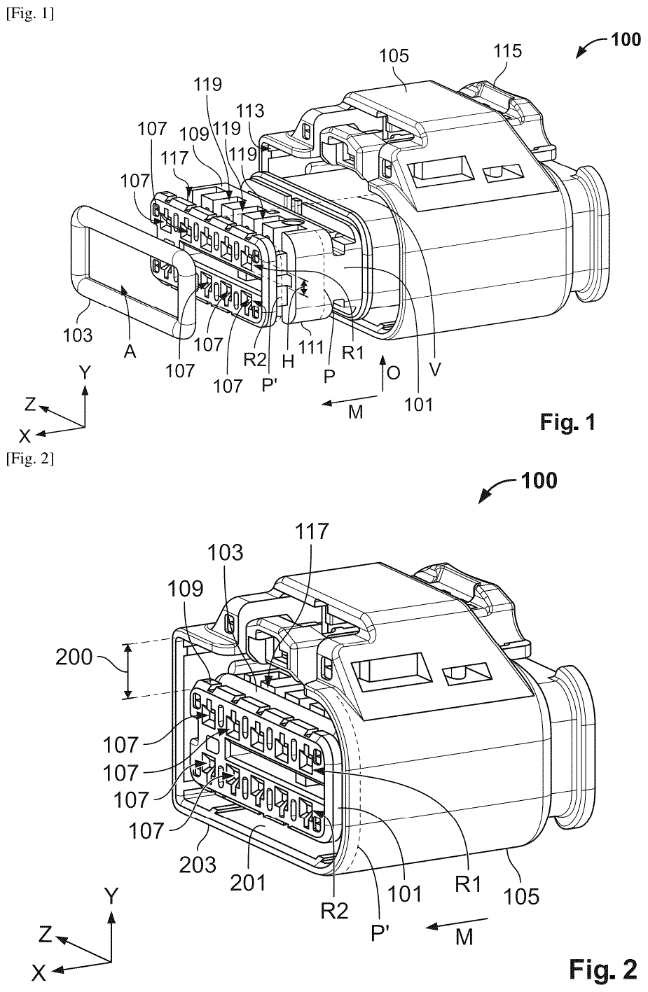

FIG. 1 is an exploded view of an electrical connector according to a first embodiment of the invention.

FIG. 2 shows the electrical connector of FIG. 1 in an unexploded perspective view.

FIG. 3 shows a cross-sectional view of a portion of the electrical connector of FIG. 1 in a non-final manufacturing state.

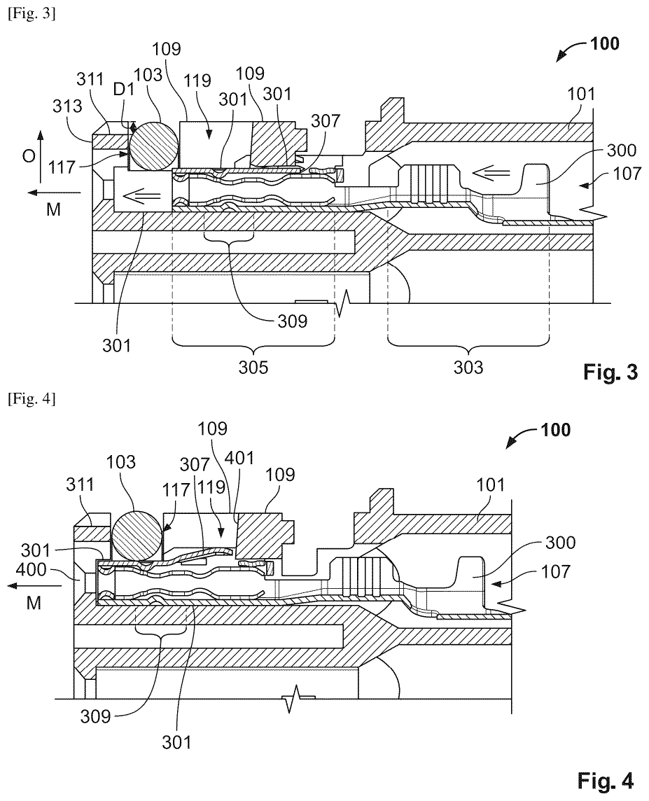

FIG. 4 shows the view of FIG. 3 wherein the electrical connector is in a final manufacturing state.

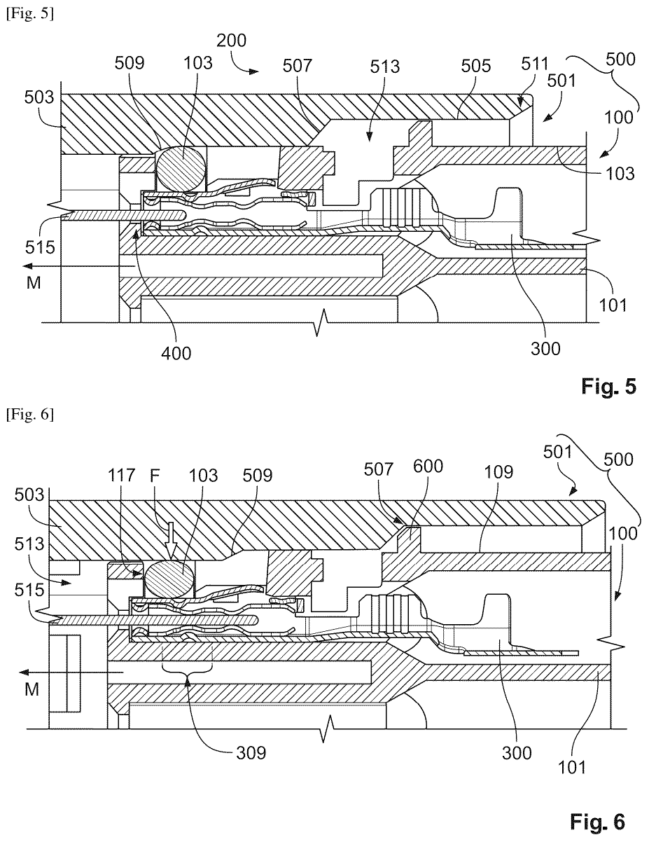

FIG. 5 shows a cross-sectional view of a portion of an electrical connector assembly comprising the electrical connector of FIG. 1, in a non-final assembly state.

FIG. 6 shows the view of FIG. 5, in a final assembly state.

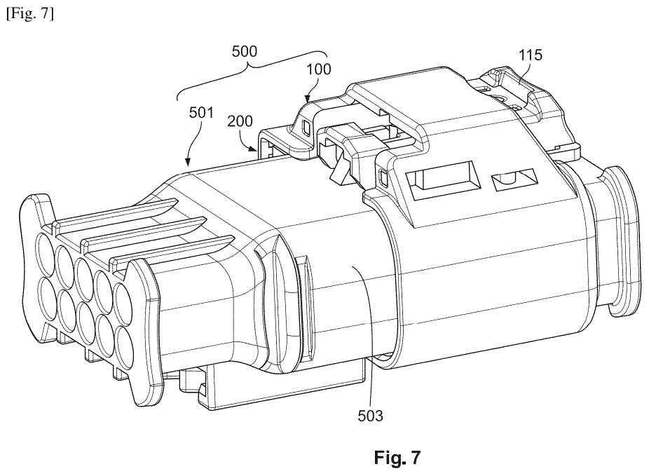

FIG. 7 shows the electrical connector assembly of FIGS. 5 and 6 in a perspective view.

In the following detailed description of embodiments, identical reference signs identified in different figures and/or in different portions of the description of the figures relate to identical elements. Further, unless explicitly mentioned otherwise, the structural features of the objects illustrated in FIGS. 1 to 7 are not drawn to scale.

The technical features and their associated advantages or effects described in the following description of embodiments can be combined with or adapted to any aspects or embodiments of the invention, together or independently, yielding further possible embodiments or aspects of the invention.

An electrical connector according to a first embodiment of the invention will now be described with respect to FIGS. 1 to 4. FIG. 1 shows the electrical connector 100 according to the invention in an exploded view. According to the present first embodiment, the electrical connector 100 is configured for electrical signalling applications in a vehicle, in particular a motor vehicle. Specifically, the electrical connector 100 is suited for electrical signalling applications in a vibration-intensive environment, for example in proximity or adjacent to an internal combustion engine of a motor vehicle.

The electrical connector 100 comprises a housing member 101, an anti-vibration element 103, and a mantle 105. In the present embodiment, the housing member 101 comprises a plurality, here ten, terminal cavities 107. The terminal cavities 107 extend through the housing member 101 along a mating direction M, parallel to a Cartesian direction x, along which the electrical connector 100 is configured to be mated with an electrical counter-connector. For example, in the present embodiment, the electrical connector 100 is configured to be mated along the mating direction M with the electrical counter-connector 501, which will be described with respect to FIGS. 5, 6 and 7.

The housing member 101 has an external housing member surface 109. In a plane P orthogonal to the mating direction M, the external housing member surface 109 defines an outer periphery of the housing member 101. Further, in this embodiment, the housing member 101 has box shape, that is, a substantially orthotope shape. Thus, in a plane P orthogonal to the mating direction M, the housing member 101 has a substantially rectangular circumference, in particular a circumference having the shape of a rectangle with rounded corners 111.

The mantle 105 has a tubular shape defining an inner space 113. The housing member 101 is configured to be fit in the inner space 113 such that the mantel 105 envelops the housing member 101, as shown on FIG. 2. The mantle 105 further comprises a connector position assurance (CPA) device 115 configured to assure the position of the electrical connector with respect to an electrical counter-connector when the electrical connector and the electrical counter-connector mated. Specifically, the CPA device 115 is configured to lock the electrical connector 100 with an electrical counter-connector, such as electrical counter-connector 501, in a correctly mated position.

The housing member 101 comprises a traversing groove 117. The traversing groove 117 extends along an outer periphery of the housing member 101. Specifically, the traversing groove 117 extends along an entire circumference the housing member 101, in particular an entire rectangular circumference in a plane P′ orthogonal to the mating direction M. As shown in FIG. 1, the traversing groove 117 has a width W, that is, an extension along the mating direction M, corresponding to between 1% and 10% of the extension along the mating direction M of the housing member 101. Alternatively or in addition, the traversing groove 117 has a width W corresponding to between 80% and 120% of the height H, that is, of the extension in a direction O orthogonal to the mating direction M and parallel to a Cartesian direction y, of the terminal cavities 107.

The traversing groove 117 traverses the housing member 101 from an outside of the housing member 101 towards the inside of the housing member 101 into each of the terminal cavities 107. Specifically, the traversing groove 117 traverses the housing member 101 from the external housing member surface 109 to each internal housing member surface 301 defining a respective terminal cavity 107 formed in the housing member 101 The internal housing member surfaces 301 are not visible on FIGS. 1 and 2 but are illustrated in FIGS. 3 to 6 and described in the following with reference thereto.

The electrical connector 100 of the first embodiment further comprises ten electrical terminals 300, and each electrical terminal 300 is respectively housed in a corresponding one of the ten terminal cavities 107. The electrical terminals 300 are not visible on FIG. 1 or 2, but an electrical terminal 300 is illustrated in FIGS. 3 to 6 and shall be described in reference thereto. In alternative embodiments, some of the terminal cavities 107 may not hold an electrical terminal. In other words, not each one of the plurality, here ten, of terminal cavities 107 must house a respective electrical terminal. Instead, the electrical connector 100 can comprise fewer electrical terminals than terminal cavities 107, for example only one, two, four, five or eight, wherein one up to nine of the terminal cavities 107 do not house a respective electrical terminal, but are instead empty.

The anti-vibration element 103 is configured as an elastic band that can be pulled over the housing member 101. Here, the anti-vibration element 103 has a rectangular ring shape, matching the extension of the outer periphery, here the rectangular circumference, of the housing member 101. The anti-vibration element 103 is configured such that in an un-stretched resting state, the anti-vibration element 103 has an inner surface area A that is smaller than the rectangular cross-sectional surface of the housing member 101, both in the plane P outside the groove 117 and in the plane P′ inside the groove 117.

Preferably, the anti-vibration element 103 has a Shore hardness between 50 and 30, preferably between 35 and 45, for example, here, 40. In a variant, the anti-vibration element 103 can also instead be torus-or donut-shaped. In an example, a commercial O-ring joint can be used as anti-vibration element 103.

The housing member 101, the anti-vibration element 103, and the mantle 105 are preferably manufactured from materials designed for operating temperatures of at least 125° C., preferably at least 150° C. The anti-vibration element 103 can be moulded in one piece, preferably from rubber or a thermoplastic elastomer. The housing member 101 can be moulded from polybutylene terephthalate (PBT).

The housing member 101 also comprises, for each terminal cavity 107, a corresponding snap-fit opening 119 to allow for a snap-fit locking of the electrical terminals 300 in their corresponding terminal cavities 107. This function will be further described with reference to FIGS. 3 and 4.

FIG. 2 shows the electrical connector 100 in a perspective view, in an assembled delivery state. The housing member 101 is fit in the mantle 105 such that a mating gap 200 is formed between the external housing member surface 109 and an inner mantle surface 201. The mating gap 200 has a mating gap opening 203 facing in the mating direction M. The mating 200 is configured to receive a shell member, for example shell member 503 as shown in FIGS. 5 and 6, of an electrical counter-connector through the mating gap opening 203 when the electrical connector 100 is mated with said electrical counter-connector.

The terminal cavities 107 are arranged in the housing member 101 in two parallel rows R1, R2 of each five terminal cavities 107. The rows R1, R2 extend in a direction perpendicular to the mating direction M. In one variant, the housing member according to the invention can also comprise only one terminal cavity. In other variants, the housing member according to the invention can comprise a different number of terminal cavities, for example two, four, seven or 20 terminal cavities, that are arranged in one row or in two rows, such as tows R1, R2. The number of terminal cavities is preferably as least as great as the number of electrical terminals.

As seen in FIG. 2, the anti-vibration element 103 is arranged in the traversing groove 117. Specifically, the anti-vibration element 103 extends along the circumference, in the plane P′ orthogonal to the mating direction M, of the housing member 101 in the traversing groove 117. Since the anti-vibration element 103 has an inner surface area A that is smaller than the rectangular cross-sectional surface of the housing member 101 in the plane P′ inside the groove 117, the anti-vibration element 103 is in a stretched state when it is arranged in the traversing groove 117.

As will be further described with reference to FIG. 3, the anti-vibration element 103 is arranged in the traversing groove 117 such that it protrudes beyond the external housing member surface 109. Specifically, FIG. 2 shows that the anti-vibration element 103 is arranged in the traversing groove 117 such that it protrudes beyond the external housing member surface 109 into the mating space 200 along at least a portion of the rectangular circumference of the housing member 101.

FIGS. 3 and 4 show a same cross-sectional view of a portion of the electrical connector 100, along the cross-sectional view cut line V indicated on FIG. 1. While in FIG. 4, the electrical connector 100 is in a final manufacturing state, in FIG. 3, the electrical connector 100 is in a non-final manufacturing state. In particular, in the view of FIG. 3, the electrical terminal 300 is not yet fully inserted and locked in the housing member 101.

As already mentioned, the electrical connector 100 comprises ten electrical terminals 300, one for each terminal cavity 107. The ten electrical terminals 300 are structurally identical and identically arranged in their corresponding terminal cavity 107 such that they are mated with mating electrical terminals of the electrical counter-connector when the electrical connector 100 is mated along the mating direction M with said electrical counter-connector.

Because in this embodiment, each of the electrical terminals 300 and the terminal cavities 107 are identical and their features and effects are mutually corresponding, the present disclosure will be limited to the description of the features and effects of one terminal cavity 107 and one electrical terminal 300.

FIG. 3 shows an electrical terminal 300 partially inserted in the mating direction M in a corresponding terminal cavity 107. The cavity 107 is defined by an internal housing member surface 301, and extends inside the housing member 101 along the mating direction M. In this embodiment, the electrical terminal 300 is stamped from an electrically conductive metal sheet. The electrical terminal 300 comprises a crimping portion 303 configured to be crimped to an electrical conductor, and a contacting portion 305 configured to electrically contact a mating electrical terminal. The crimping portion 303 is joined to the contacting portion 305 longitudinally in the mating direction M.

In this embodiment, the electrical terminal 300 is a socket contact terminal, or female contact, and is thus configured to receive a pin contact terminal, or male contact, when the electrical connector 100 is mated with a mating electrical counter-connector. Preferably, the electrical terminal 300 is a copper contact with tin, silver or gold coating.

The electrical contact 300 comprises an elastic lance 307 protruding outwardly, transversally to the mating direction M, and configured as cantilever snap-fit device. In the partially inserted view of FIG. 3, the electrical terminal 300 is in an intermediate insertion state in which the elastic lance 307 has not reached the snap-fit opening 119. Thus, the elastic lance is still bent downwards, that is, inwards towards the electrical terminal 300 body, by the internal housing member surface 301, and the electrical terminal 300 is not locked to the housing member 101.

The electrical terminal comprises an internally narrowed portion 309. The internally narrowed portion 309 is configured to realize an electrical contact with a mating pin contact terminal when the electrical connector 100 is mated with an electrical counter-connector.

The traversing groove 117 extends through the housing member 101 in a direction O orthogonal to the mating direction, from an outside of the electrical connector 100 towards the terminal cavity 107. Specifically the traversing groove 117 traverses the housing member 101 from the external housing member surface 109 to the internal housing member surface 301 defining the terminal cavity 107.

The anti-vibration element 103 is arranged in the traversing groove 117 such that it protrudes beyond the external housing member surface 109. Specifically, the anti-vibration element 103 is arranged in the traversing group 117 such that it protrudes beyond the front portion 311 of the external housing member surface 109, the front potion 311 being adjacent to the traversing groove 117 on the side facing in the mating direction M. The front portion 311 extends in the mating direction M from the traversing groove 117 to the distal extremity 313 of the housing member 101. The anti-vibration element 103 protrudes beyond the front portion 311 by a distance D1.

FIG. 4 shows a view corresponding to the view of FIG. 3 in which the electrical connector 100 is in a final manufacturing state. In particular, the electrical terminal 300 is fully inserted in the terminal cavity 107, such that the electrical terminal 300 is correctly housed in the terminal cavity 107 and locked, in particularly snap-fit, to the housing member 101.

That is, the electrical terminal 300 has been inserted further into the terminal cavity 107 in the mating direction M, such that the elastic lance 307 has moved into a position in which it can extend into the snap-fit opening 119. FIG. 4 shows that the elastic lance 307 is extended back outwardly into its resting position, such that the electrical terminal 300 is locked between a narrowed terminal cavity opening 400 and a snap-fit stopper surface 401 of the snap-fit opening 119 in the housing member 101.

In the final manufacturing state shown in FIG. 4, the electrical terminal 300 is frictionally engaged with the anti-vibration element 103 arranged in the traversing groove 117 that traverses the housing member 101 into the terminal cavity 107. As can be seen, the traversing groove 117 traverses the housing member 101 to a portion of the internal housing member surface 301 that is face-to-face with the internally narrowed portion 309 of the electrical terminal 300 when said electrical terminal 300 is fully inserted in the terminal cavity 107.

In this final manufacturing state of FIG. 4, the electrical terminal 300 is frictionally engaged with the anti-vibration element 103 arranged in the traversing groove 117 such that the electrical terminal 300 is further stabilised in the terminal cavity 107. In particular, the electrical terminal 300 is specifically frictionally engaged with the internally narrowed portion 309 of the electrical terminal 300. This allows electrical terminal 300 to be advantageously stabilised at the point of electrical contact in the case of a mating with a mating pin contact terminal.

The anti-vibration element 1033 is arranged in the traversing groove 117 all along the circumference of the housing member 101. Thus, the anti-vibration element 103 is in the same contact, in particular frictional engagement, with each of the ten electrical terminals 300 arranged in their respective terminal cavities 107, both in a row R1 and row R2.

In the presently described first embodiment of the invention, the anti-vibration and 103 protrudes only marginally into the terminal cavity 107, not visible on FIG. 3 and FIG. 4. This allows for a light frictional engagement between the anti-vibration element 103 and the electrical terminal 300. However, in variants, the anti-vibration element can be arranged in the traversing groove such that it protrudes, that is, goes beyond the internal housing member surface, into the terminal cavity by a distance, for example the distance D1.

A method for manufacturing an electrical connector according to a second embodiment of the invention will now be described with reference to FIGS. 1 to 4. The method according to the second embodiment described in the following is a method for manufacturing the electrical connector 100 already described in the foregoing.

The method starts with a step A of providing the housing member 101. As already described with reference to FIGS. 1 to 4, the housing member 101 comprises the traversing groove 117 traversing the housing member 101 from an external housing member surface 109 to at least one of the internal housing member surfaces 301 that define the terminal cavities 107.

In a step B, the anti-vibration element 103 is arranged in the traversing groove 117 such that the anti-vibration element 103 protrudes beyond the external housing member surface 109, in particular the front portion 311, as described with reference to FIGS. 3 and 4. For this purpose, the anti-vibration element 103 is elastically stretched, for example manually, to be to be slipped over the external housing member surface 109 into the traversing groove 117. As already mentioned, the anti-vibration element 103 is dimensioned such that it contracts inwards when reaching the traversing groove 117. Thus, the anti-vibration element 103 is firmly lodged in the traversing groove 117 and can provide an inward force to stabilise the electrical terminals 300.

In a step C, an electrical terminal 300 is inserted along the mating direction M in the corresponding terminal cavity 107 such that the electrical terminal 300 is in contact with the anti-vibration element 103. As described specifically earlier, the electrical terminal 300 is inserted in the mating direction M into the terminal cavity 107 until said electrical terminal 300 is snap-fit to the housing member 101 and the internally narrowed portion 309 of the electrical terminal 300 is frictionally engaged and face-to-face with the anti-vibration element 103.

An electrical connector assembly according to a third embodiment of the invention will now be described with reference to FIGS. 5, 6 and 7. The electrical connector assembly 500 of the third embodiment comprises the electrical connector 100 of the first embodiment of the invention, and an electrical counter-connector 501. The electrical counter-connector 501 is configured to be mated with the electrical connector 100 to realise the electrical contacting of the ten electrical terminals 300 with ten mating electrical terminals 503 of the electrical counter-connector 501.

FIGS. 5 and 6 show a cross-sectional view of a portion of the electrical connector assembly 500 along the cross-sectional view line V indicated on FIG. 1. Specifically, FIGS. 5 and 6 show the same cross-sectional view of a portion of the electrical connector 100 as seen in FIGS. 3 and 4, wherein the electrical connector 100 is in different mating states of the mating with the electrical counter-connector 501. While in FIG. 6, the electrical connector assembly 500 is in a final assembly state, that is, the connectors 100, 501 are fully mated, in FIG. 5 the electrical connector assembly 500 is not yet fully assembled. In FIG. 5, the electrical connector assembly 500 is in an intermediate mating state.

FIG. 5 shows a shell member 503 of the electrical counter-connector 501. The shell member 503 configured as an enveloping shell, as seen on FIG. 7. The shell member 503 extends along a direction parallel to the mating direction M and comprises an inner surface 505 configured to be mated with the external housing member surface 109. The inner surface 505 of the shell member 503 comprises a stopping step 507 and a chamfered portion 509. The stopping step 507 is closer to the distal extremity 511 of the shell member 501 than the chamfered portion 509. The chamfered portion 509 is configured such that it narrows the shell space 513 of the shell member 503 in the mating direction M, that is, away from the distal extremity 511

The electrical counter-connector 501 further comprises at least one, here ten mating electrical terminals 515. The mating electrical terminals 515 are a pin contact terminals configured to be received in corresponding socket contact terminals, such as the electrical terminals 300. As in the present embodiment, the mating electrical terminals 515 are identical and arranged in a corresponding fashion to mate corresponding electrical terminals 300, only one mating electrical terminal 515 and its mating will described in the following.

In the intermediate mating state shown in FIG. 5, the electrical connector 100 has been plugged over the electrical counter-connector 501 in the mating direction M such that the housing member 101 has been partially inserted in the electrical counter-connector 500. That is, the shell member 503 has partially slid into the mating space 200.

Thus, the shell member 503 has slid over the external housing member surface 109 of the housing member 101 of the electrical connector 100. However, the stopping step 507 has not yet abutted, and the chamfered portion 503 has not yet reached the anti-vibration element 103. The pin terminal 515 has partially entered the electrical terminal 300 through the narrowed terminal cavity opening 400.

In FIG. 6, the electrical connector assembly 500 is in a final assembly state. That is, the electrical connector 100 and the electrical counter-connected 501 are fully mated. In particular, as the electrical connector 100 has further moved in the mating direction M such that housing member 101 has further moved into the shell space 513, the shell member 503 has further slid over the external housing member surface 109. The shell member 503 has slid over the external housing member surface 109 until the stopping step 507 has abutted against a stopper 600 protruding outwardly from the housing member 101.

At the same time, the chamfered portion 509 has reached and slid over the anti-vibration element 103. As the chamfered portion 509 narrows the shell space 515 in the mating direction M, the chamfered portion 509 has engaged with the anti-vibration element 103 protruding outwardly beyond the external housing member surface 109 of the housing member 101. As the shell space 515 defined by the shell member 503 is narrowed by the chamfered portion 509, further mating movement pushing the connectors 100, 501 together has pressed the anti-vibration element 103 deeper into the traversing groove 117.

In particular, the shell member 503, in the mated electrical connector assembly, exerts a compression force F orthogonal to the mating direction M on the anti-vibration element 103, pushing the anti-vibration element 103 into the traversing groove 117 and against the electrical contact 300. In other words, the anti-vibration element 103 is compressed and sandwiched between the shell member 503 and the electrical contact 300. The chamfered portion 509 allows for a gradual increase of the compression force F up to its maximal value when the anti-vibration element 103 is moved in the mating direction M over the chamfered portion 509.

FIG. 6 shows that in the fully mated state, the pin terminal 515 has moved further into the electrical terminal 300 realising an electrical contact at the internally narrowed portion 309. As the anti-vibration element 103 is compressed between the shell member 503 and the electrical contact 300, a direct mechanical link is established there-between. This further stabilises the electrical terminal 300 in its terminal cavity 107, reducing the potential for micro-movements of the electrical terminal 300 with respect to the housing member 101 that may, due to manufacturing tolerances, subsist even after snap-fitting of the electrical terminal 300 in the terminal 107.

In addition, as a direct mechanical link is established between the electrical terminal 300 and the shell member 503, the vibrations of the electrical counter-connector 501, which may be different from the vibrations of the housing member 101 of the electrical connector 100, can be transferred to the electrical terminal 300. That is, the electrical terminal 300 can advantageously vibrate with the electrical counter-connector 501 and its mating electrical terminal 515. As the electrical terminals 300 and 515 vibrate in conjunction, fretting corrosion is reduced.

FIG. 7 shows the electrical connector assembly of FIGS. 5 and 6 in a perspective view. As can be seen, the electrical connector 100 is plugged over the electrical counter-connector 501 such that the shell member 503 is received in the mating space 200. Thus, the shell member 503 envelops the circumference of the housing member 101 along its external housing member surface 109.

Therefore, the shell member 503 can exert the compression force F all along the circumference of the housing member 101, in particular along the circumference of the anti-vibration element 103. In this way, the shell member 503 also compresses the one anti-vibration element 103 against each of the other ones of the ten electrical terminals 300 in their corresponding terminal cavities 107.

In view of the above-described electrical connector assembly 500, a method for assembling an electrical connector assembly according to a further, fourth, embodiment of the invention will now be described. The method according to the fourth embodiment described in the following is a method for assembling the electrical connector assembly 500, whose features were already described in the foregoing.

The method for assembling electrical connector assembly according to the fourth embodiment starts with a step D of mating the housing member 101 and the shell member 503 such that the shell member 503 envelops the housing member 101. In particular, the electrical connector 100 is plugged over the electrical counter-connector 501 such that the shell member 503 is inserted in the mating space 200, and the housing member 101 is inserted in the shell space 515. Thus, the inner surface 505 is slid over the circumference of the external housing member surface 109 of the housing member 101.

The method according to the fourth embodiment further comprises a step E of compressing the anti-vibration element 103 between the shell member 503 and the electrical terminal 300. A chamfered portion 509 narrows the shell space 515, and thus the inner surface 505 of the shell member 503 engages with the anti-vibration element 103. Specifically, the shell member 503 exerts a compression force F in a direction orthogonal to the mating direction M on the anti-vibration element 103 against the electrical terminal 300. That is, the anti-vibration element 103 is sandwiched between the shell member 503 and the electrical terminal 300.

The here-above described embodiments of the invention each provide an electrical contacting solution with improved vibration-resistance and improved durability in vibration-intensive environments.

### Reference Signs

100 electrical connector

101 housing member

103 anti-vibration element

105 mantle

107 terminal cavity

109 external housing member surface

111 rounded corners of the housing member

113 inner space of the mantle

115 CPA device

117 traversing groove

119 snap-fit opening

200 mating gap

201 inner mantle surface

203 mating gap opening

300 electrical terminal

301 internal housing member surface

303 crimping portion

305 contacting portion

307 elastic lance

309 internally narrowed portion

311 front portion of the external housing member surface

313 distal extremity of the external housing member surface

400 narrowed terminal cavity opening

401 snap-fit stopper surface

500 electrical connector assembly

501 electrical counter-connector

503 shell member

505 inner surface of the shell member

507 stopping step formed on the inner surface of the shell member

509 chamfered portion formed on the inner surface of the shell member

511 distal extremity of the shell member

513 shell space

515 mating electrical terminal

600 stopper

A inner surface area of the anti-vibration element

D1 distance of external protrusion of the anti-vibration element

F compression force

H height of a terminal cavity

M mating direction

O direction orthogonal to the mating direction

P, P′ plane orthogonal to the mating direction

R1, R2 rows of terminal cavities

V cross-sectional line

1. An electrical connector configured to be mated with an electrical counter-connector (501) along a mating direction, the electrical connector comprising:
a housing member, one electrical terminal housed in a corresponding terminal cavity of the housing member, and an anti-vibration element;
the housing member having a traversing groove traversing housing member the from an external housing member surface to an internal housing member surface that defines the corresponding terminal cavity; and
the anti-vibration element is arranged in the traversing groove.

2. The electrical connector according to claim 1, wherein the anti-vibration element is arranged in the traversing groove such that the anti-vibration element protrudes beyond the external housing member surface.

3. The electrical connector according to claim 1, further comprising:
a plurality of the electrical terminals housed in a respective plurality of corresponding terminal cavities of the housing member;
wherein the traversing groove extends along an outer periphery, in particular along the entire circumference, of the housing member such that it traverses the housing member from the external housing member surface to each of the respective internal housing member surfaces that define the plurality of corresponding terminal cavities; and
wherein the anti-vibration element is arranged in the traversing groove such that it protrudes beyond the external housing member surface along the outer periphery, in particular the entire circumference of the housing member.

4. The electrical connector according to claim 1, wherein the anti-vibration element is formed in a shape matching the outer periphery of the housing member, the housing member has a rectangular circumference in a plane orthogonal to the mating direction, and the anti-vibration element has a matching rectangular ring shape.

5. The electrical connector according to claim 1, wherein the anti-vibration element is arranged in the traversing groove such that it is frictionally engaged with the one or plurality of electrical terminals, wherein the anti-vibration element protrudes beyond the internal housing member surfaces that define the one or plurality of corresponding terminal cavities, into said one or plurality of corresponding terminal cavities.

6. The electrical connector according to claim 1, wherein each of the one or plurality of electrical terminals is a socket contact terminal comprising an internally narrowed portion configured to realize an electrical contact with a mating pin contact terminal, wherein for each electrical terminal, the traversing groove traverses the housing member from the external housing member surface to a portion of the internal housing member surface defining the corresponding terminal cavity that is face-to-face with the respective internally narrowed portion of the electrical terminal.

7. An electrical connector assembly, comprising:
the electrical connector according to claim 1; and
an electrical counter-connector, the electrical counter-connector comprising a shell member;
wherein the electrical counter-connector is mated with the electrical connector such that the shell member envelops the housing member and the anti-vibration element is compressed between the shell member and the one or plurality of electrical terminals.

8. The electrical connector assembly according to claim 7, wherein the shell member comprises an inner surface with a chamfered portion configured to engage with the anti-vibration element.

9. A method for assembling the electrical connector assembly as recited in claim 7, comprising the steps of:
mating the housing member and the shell member such that the shell member envelops the housing member; and
compressing the anti-vibration element between the shell member, in particular a chamfered portion of an inner surface of the shell member, and the electrical terminal.

10. A method for manufacturing an electrical connector as recited in claim 1, comprising the steps of:
providing a housing member comprising a traversing groove traversing the housing member from an external housing member surface to an internal housing member surface that defines a terminal cavity for an electrical terminal;
arranging an anti-vibration element in the traversing groove such that the anti-vibration element protrudes beyond the external housing member surface; and
inserting an electrical terminal in the terminal cavity, preferably such that the electrical terminal, in particular an internally narrowed portion of the electrical terminal configured to realize an electrical contact with a mating electrical terminal, is in contact with, in particular frictionally engaged with, the anti-vibration element.
